(19) United States
(12) Patent Application Publication
(10) Pub. No.: US 2005/0154085 A1
(43) Pub. Date: Jul. 14, 2005

(54) Granulated optical brightening agents

(76) Inventors: Thomas Martini, Kelkheim-Fischbach (DE); Alexander Lerch, Mittelstrasse Geinhausen (DE); Hans Joachim Metz, Jahnstrasse Darmstadt (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/497,630

(22) PCT Filed: Dec. 2, 2002
(86) PCT No.: PCT/EP02/13590

(30) Foreign Application Priority Data
Dec. 5, 2001 (DE) 101597134

(51) Int. Cl. C08K 9/10

(52) U.S. Cl. 523/210

(57) ABSTRACT

The invention relates to granulated optical brightening agents that are coated with a wax.

Optical brighteners for plastics are marketed as fine powders which are not flowable and are very likely to generate dust during the loading process. The environmental disadvantages associated with these dusts are well-known. An additional risk associated with the direct use of these powders is that irregularities can occur in the brightened plastic, because if variations occur in the grain size of the brightener particles, non-uniformity is also found in the brightened plastic. For example, when polyethylene-vinyl acetate is brightened, and also in the case of polyvinyl fluoride, the powder-application of the brightener can lead to an irregular fluorescent appearance, which is particularly discernible as spots and streaking under UV light (max. 376 nm). Such products do not meet the user's quality requirements.

It is an object of the present invention to formulate an optical brightener in such a way that it is firstly dust-free and has free-flow properties during handling, and secondly gives homogeneous brightening effects in plastics.

It has now been found that pelletized brighteners prepared via coating of the brightener powder with a wax meet these requirements.

The application technology for treating plastics additives with waxes is prior art. The simplest method for this is premixing of the brightener with a pulverized wax and heating the mixture to the softening point of the wax slow cooling to room temperature with rotation of the container gives dust-free flowable pellets. It is also possible to mix wax emulsions or water-dispersible wax formulations homogeneously with the plastics additive in an aqueous medium, optionally at an elevated temperature with stirring, producing a wax-treated pelletized form of the additive.

Other possible processes are described in JP 10251533, where the wax coating takes place by way of an isobutanol finish. The same applies to the use described in DE-A1 29 40 156 and WO 92/07912 of a fluidized-bed process. Other suitable processes are wax application by spraying as described in DE 39 35 815 C2, or wax application by means of spray drying as described in EP 1 081 195.

The processes described encapsulate or coat the particles of the relevant optical brightener with the wax or with a waxy polymer.

The inventive brightener/wax pellets have a particle diameter of from 0.05 to 5 mm. Particular preference is given to pellets with a diameter from 0.1 to 2 mm, because these have very good free-flow properties, can be metered effectively, and generate little dust, and after application give homogeneous brightening.

There is no unique chemical definition of waxes, which form a group of substances with identical or similar usage properties, characterized by particular physical properties.

The term “wax” therefore indicates a series of naturally occurring or synthesized substances which generally have the following properties: at 20° C. kneadable, solid to hard and brittle, coarsely to finely crystalline, translucent to opaque, but not glassy; above 40° C. melting without decomposition, and even just slightly above the melting point having relatively low viscosity and not stringing, highly temperature-dependent consistency and solubility, polishable by applying slight pressure (cf. Ullmanns Encylopädie der technischen Chemie [Ullmanns Encyclopedia of Industrial Chemistry], Volume 24, 4th Edition 1983, pp. 1-49 Verlag Chemie, Weinheim and Römpps Chemie-Lexikon [Römpps Chemical Encyclopedia], Volume 6, 8th Edition 1988, p. 463, Franck'sche Verlagsbuchhandlung).

Preferred waxes are: naturally occurring waxes, such as vegetable waxes, e.g. carnauba waxes, candelilla waxes, animal waxes, e.g. beeswax, modified naturally occurring waxes, e.g. paraffin wax, microwaxes, semisynthetic waxes, e.g. montan ester waxes, or entirely synthetic waxes, such as polyolefin waxes, e.g. polyethylene and polypropylene waxes, polyethylene glycol waxes, cycloolefin polymer waxes, amide waxes, e.g. N,N′-distearylethylenediamine.

Particular preference is given to polyolefin waxes, and also to polyolefin waxes containing polar groups, produced via subsequent oxidation of the polyolefin wax, or via a graft reaction with monomer in which carboxylic acid groups, carboxylic ester groups, carboxylic anhydride groups, or hydroxy groups are present.

Suitable waxy polymers are relatively high-molecular-weight compounds which have a waxy character and which have preferably been prepared via polycondensation processes or polyaddition processes, e.g. thermoplastic polyester, epoxy, styrene-acrylate copolymer, styrene-butadiene copolymer, or cycloolefin copolymer resins, e.g. ®Topas.

In order that these polymers have adequate solubility at an elevated temperature in the plastic and also in organic solvents, their number-average molecular weight is mostly up to 20 000. Preference is given to waxes whose number-average molecular weight is up to 10 000, particularly preferably up to 5000.

The drop point of the waxes used according to the invention, or the softening point of these polymers, is preferably in the range from 60 to 180° C., particularly preferably in the range from 80 to 140° C.

The amount and the nature of the wax or polymer may vary, depending on the application sector for the pellets, especially in order to ensure compatibility with the application medium.

In order to produce a defined property profile, it is also possible to use a mixture composed of two or more different waxes or polymers.

The optical brighteners used are non-ionic and, whatever the chemical structure, characterized by absorbing in the range from 270 to 400 nm and emitting in the visible spectrum from 400 to 450 nm. Preferred optical brighteners are represented by the formulae 1 to 5.

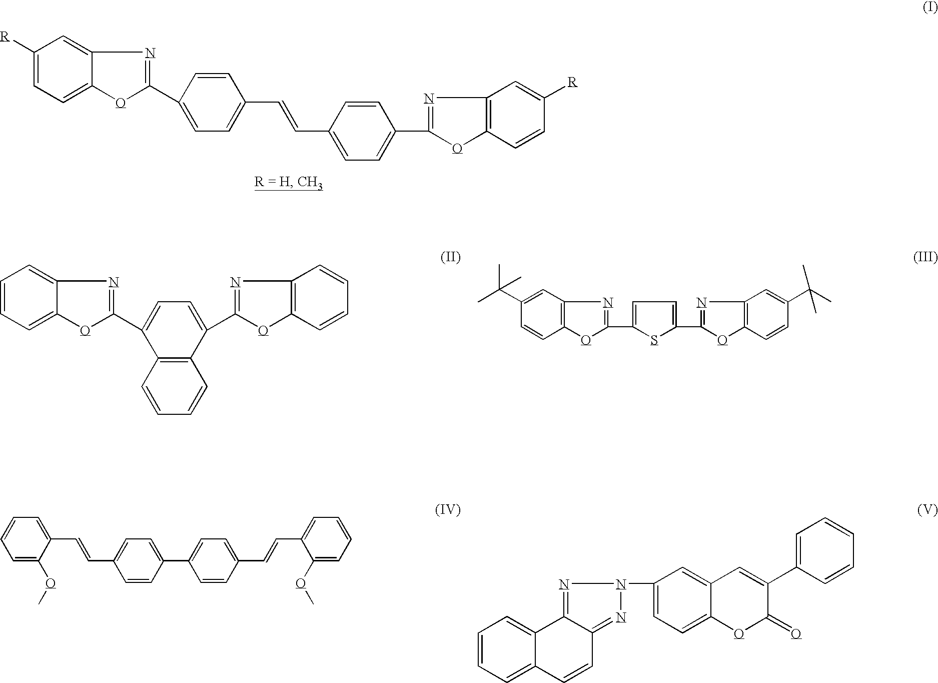

The amounts of optical brighteners, based on the plastic to be brightened, are normally from 1 to 1000 ppm, depending on the plastic and on the whiteness to be achieved. When preconcentrates are prepared it is also possible to use amounts of from 0.1 to 30%, based on the total weight of the plastic. The optical brighteners may be used individually or in a mixture. Synergistic effects can also be observed here.

The pellets may be used for the brightening of high-molecular-weight organic materials. These may be of natural or synthetic origin. By way of example, they may comprise naturally occurring resins, drying oils, or rubber. However, they may also comprise modified natural substances, e.g. chlorinated rubber, cellulose derivatives, and in particular comprise highly synthetic organic polymers (plastics) which have been prepared via polymerization, polycondensation, or polyaddition. Among the class of plastics prepared via polymerization, mention may particularly be made of the following: polyolefins, e.g. polyethylene, polypropylene, polyisobutylene, substituted polyolefins, e.g. polystyrene, polyvinyl chloride, polyvinylidene chloride, polyvinyl acetals, polyacrylonitrile, polyacrylic acid, and polymethacrylic acid, and their respective esters, or polybutadienes, and also copolymers of these.

From the class of plastics prepared via polyaddition and polycondensation, mention may be made of: polyesters, polyamides, polyimides, polycarbonates, polyurethanes, polyethers, polyacetals, and also condensates of formaldehyde with phenols or urea, thiourea, or melamine. The high-molecular-weight material mentioned may be present individually or in a mixture in the form of plastics compositions or melts. It may also be present in the form of its monomers, which are polymerized after addition of the brightener.

Very particularly good effects are obtained when copolymers composed of ethylene and vinyl acetate, or polyethylene-vinyl acetate are brightened, or else with polyvinyl chloride.

The improvement in evenness is particularly noticeable when the plastic to be brightened is subjected to foaming after treatment.

The high-molecular-weight organic material mentioned may be present individually or in mixtures in the form of plastics compositions or melts. It is also possible for the inventive form of the optical brighteners to be incorporated into the monomers underlying the polymers and for the corresponding plastic to be brightened via polymerization of the monomer-comprising brightener. The amount advantageously used of the optical brightener is from 50 to 99% by weight, preferably from 60 to 95% by weight, the amount of the wax or polymer being from 1 to 50% by weight, preferably from 5 to 40% by weight, of the brightener pellets.

### EXAMPLE 1

150 parts of the montan wax ester Licolub® WE 40 (acid number 13-26 KOH/g) are mixed homogeneously, at room temperature in a glass container for 2 hours on a roller bed with 850 parts of the brightener of the formula 1. The mixture is then held motionless at 105° C. for 10 hours under N₂. Cooling to RT takes place within a period of 6 hours with slow rotation, the rotation rate being about 16 rpm. This gives dust-free pellets with good free-flow properties, with a grain diameter of from 0.5 to 5 mm.

The dusting performance of the pellets is determined photometrically with the aid of equipment for measuring sedimentation dust. The dust value is 2. The pulverulent brightener substance of the formula 1 on which the pellets are based has a dust value of 14.

(1=dusting level zero; 16=dusting level high)

### EXAMPLE 2

A mixture composed of
80.8 parts of polyethylene-vinyl acetate
16.2 parts of CaCO₃
0.8 part of stearic acid
0.8 part of zinc oxide
1.4 parts of foaming agent, e.g. azodicarbonamide and 0.04 part of the conventional-formulation brightener of the formula 1 (purity >99%) are treated on a roll mill for 10 min at 165° C. so as to produce a sheet of thickness about 2 mm.

The resultant sheet is observed under UV light with an intensity maximum at 376 nm.

The appearance is non-homogeneous, with speck-like, local irregularities.

### EXAMPLE 3

The procedure is as in Example 2. However, the brightener used comprises 0.046 part of the pellets of Example 1. The resultant sheet has uniform fluorescence.

### EXAMPLE 4

A mixture composed of
67.0 parts of polyvinyl chloride
30.6 parts of diisodecyl phthalate
1.9 parts of dibutyltin thioglycolate
0.5 part of titanium dioxide (anatase)
is treated with 0.1 part of a conventional-formulation brightener of the formula 2. The mixture is heated for 10 min at 130° C. on the roll mill, and optimum distribution of the brightener within the composition is achieved by continuously stripping the sheet of thickness 1 mm and then returning it to the milling process.

The sheet is drawn off and, as described in Example 2, samples are studied under UV light, and have discernible irregularities in the form of streaking.

### EXAMPLE 5

The procedure is as in Example 4. However, the brightener used comprises 0.115 part of the brightener formulation from experiment 1. The PVC sheet obtained fluoresces homogeneously under UV light.

### EXAMPLE 6

The procedure is as in Example 1.

However, the amount of wax used is 500 parts. The brightener used comprises 500 parts of a commercially available product of the formula 1. This gives dust-free pellets with excellent free-flow properties.

### EXAMPLE 7

The procedure is as in Example 4. However, the brightener incorporated comprises 0.02 part of the brightener of the formula 1. When samples are studied under UV light, streaking is discernible.

### EXAMPLE 8

The procedure is as in Example 7. However, the brightener used comprises 0.04 part of the brightener prepared to formula 6. The PVC sheet obtained fluoresces homogeneously.

1. A pelletized optical brightener encapsulated a wax or waxy polymer.

2. The pelletized optical brightener as claimed in claim 1, wherein the wax is a polyolefin wax.

3. The pelletized optical brightener as claimed in claim 1, wherein the amount present of the wax or waxy polymer is from 1 to 50% by weight.

4. The pelletized optical brightener as claimed in claim 1, having a particle diameter of from 0.05 to 5 mm.

5. A process for preparing a pelletized optical brightener as claimed in claim 1, comprising the steps of homogeneously mixing the optical brightener and the wax or waxy polymer at room temperature to form a mixture, heating the mixture above the softening point of the wax or waxy polymer, and cooling the mixture with slow rotation.

6. A high-molecular-weight organic material brightened by at least one of the pelletized optical brighteners of claim 1.

7. A process for preparing a pelletized optical brightener as claimed in claim 1, comprising the steps of homogeneously mixing the optical brightener and the wax or waxy polymer at room temperature to form a mixture, heating the mixture above the softening point of the wax or waxy polymer, and cooling the mixture.

8. The process as claimed in claim 7, wherein the mixture is cooled to room temperature.

9. A process for optically brightening a high-molecular-weight organic material comprising the step of mixing the pelletized optical brightener according to claim 1 with the high-molecular-weight organic material during formation of the high-molecular-weight organic material.

10. The pelletized optical brightener as claimed in claim 1, wherein the optical brightener is a compound of the formula (I) through (V):

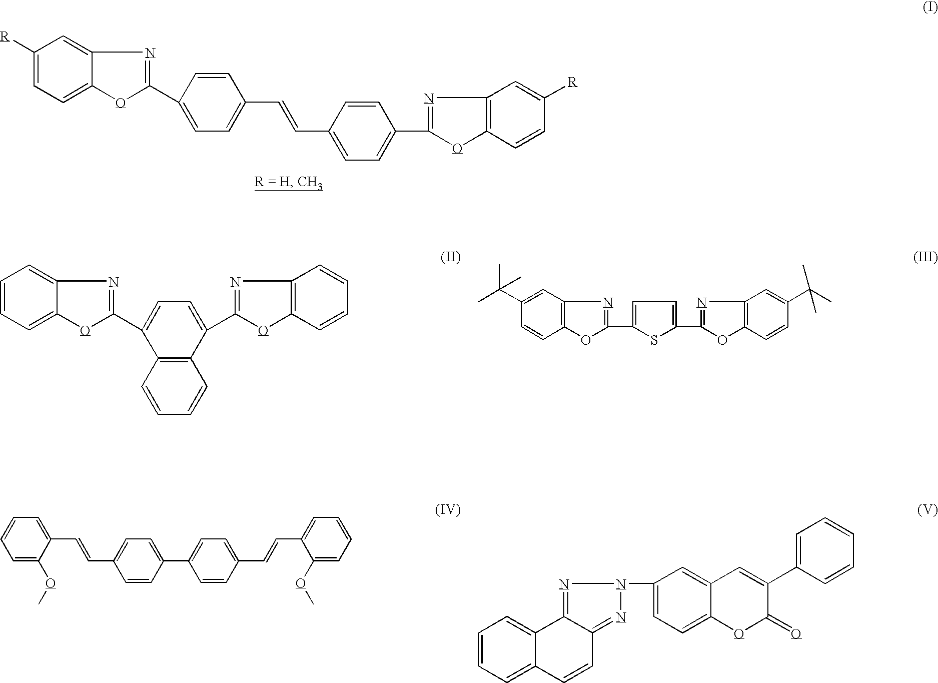

11. The process as claimed in claim 9, wherein the high-molecular weight material is selected from the group consisting of copolymers of ethylene and vinyl acetate, polyethylene-vinyl acetate and polyvinyl chloride.
